(19) United States
(12) Patent Application Publication
(10) Pub. No.: US 2024/0391346 A1
(43) Pub. Date: Nov. 28, 2024

(54) MANAGING ELECTRIC VEHICLE CHARGING THROUGH A SMART METER

(71) Applicant: SAN DIEGO GAS & ELECTRIC COMPANY, San Diego, CA (US)

(72) Inventor: James McCLOSKEY, San Diego, CA (US)

(73) Assignee: SAN DIEGO GAS & ELECTRIC COMPANY, San Diego, CA (US)

(21) Appl. No.: 18/791,113

(22) Filed: Jul. 31, 2024

Related U.S. Application Data
(63) Continuation-in-part of application No. 17/468,513, filed on Sep. 7, 2021.

(51) Int. Cl. B60L 53/68; B60L 53/62; B60L 53/66; H04L 9/40

(52) U.S. Cl. CPC B60L 53/68; B60L 53/62; B60L 53/665; H04L 63/083

(57) ABSTRACT

A system and method for remotely managing electric power transfer comprising a power source, an electric vehicle charging device configured to transfer electric power from the power source to an electric vehicle, and a smart meter device coupled to the charging device on one end and the power source on another end. The smart meter device is configured to control the electric power transferred by the electric vehicle charging device (EVSE) is provided. The user may begin charging session by being authenticated using an NFC tag, an RFID badge, or LPR technology.

### RELATED APPLICATIONS

This application a continuation-in-part of U.S. patent application Ser. No. 17/468,513, filed on Sep. 7, 2021, the contents of which are incorporated herein by reference in its entirety.

### TECHNICAL FIELD

This disclosure relates generally to electrical components, and more specifically to electrical installations to allow for the remote control via utility smart meters of electric vehicle charging stations from the power grid.

### BACKGROUND

As more consumers adopt electric vehicles (EVs), the need for vehicle charging facilities grows. Electric vehicles include battery-electric and plug-in hybrid vehicles, each of which are charged from an external power source through electric vehicle supply equipment (EVSE), also referred to as charging stations.

Entities like workplaces or corporate fleet operators may install charging stations in private settings for use by employee or fleet vehicles. These entities are referred to as charging site operators and may own the EVSE, or the EVSE may be owned and operated by third parties. Both charging site operators and third-party EVSE operators require an efficient means to authenticate drivers, manage charging power dispensing, and have a way to associate charging session with individual users for billing purposes.

### BRIEF SUMMARY OF EMBODIMENTS

In accordance with one or more embodiments, various features and functionality can be provided to enable or otherwise facilitate automated administration of customer email messages sent to a customer service representative.

The disclosed technology describes a system that allows remote control of vehicle charging at EVSE using ICM (Installation Control Module) smart meter technology. The disclosed technology enables management of EV charging by utilizing the remote connect/disconnect capabilities of ICM smart meters. Vehicle operators are able to control vehicle charging through a client computing device.

In some embodiments, a system may provide a solution for remotely managing electric power transfer. The system may include a power source, an electric vehicle charging device, a smart meter device, and a smart meter control server. The electric vehicle charging device may be configured to transfer electric power from the power source to an electric vehicle.

In some embodiments, the smart meter device may be coupled to the electric vehicle charging device on one end and the power source on another end. Additionally, the smart meter device may be configured to transmit electrical charging data and receive remote commands, via a wireless network, for controlling the electric power being transferred by the electric vehicle charging device. In some embodiments, the smart meter device may be configured to communicate with the smart meter control server via a smart meter network.

In some embodiments, the smart meter device may include a measurement module and a communication module. For example, the measurement module of the smart meter device may include a processor and a memory, and may be configured to collect and store voltage and current information associated with electric power transferred from the power source to the electric vehicle via the electric vehicle charging device. Similarly, the communication module of the smart meter device may be configured to transmit the voltage and the current information collected by the measurement module to the smart meter control server. In other embodiments, the measurement module of the smart meter device may generate a data record for the electric power transferred from the power source to the electric vehicle via the electric vehicle charging device, wherein the record is transmitted to the smart meter server by the communication module of the smart meter device.

In some embodiments, the smart meter control server may be communicatively coupled to the smart meter device. Furthermore, the smart meter control server is configured to receive user input transmitted via a mobile network. For example, user input may include authentication credentials received from a mobile device operated by a user. Additionally, user input may include NFC tag information transmitted by the mobile device operated by the user, RFID badge information transmitted by an RFID scanner, and license plate information transmitted by an LPR scanner.

In some embodiments, the smart meter control server may be configured to verify that the user input (e.g., authentication credentials) matches user account credentials associated with the user to permit power transfer to the electric vehicle. Upon verifying that the authentication credentials match the user account credentials, the smart meter control server may be configured to remotely control the smart meter device by transmitting various commands to the smart meter device. For example, a start command, which causes the smart meter device to permit the electric vehicle charging device to start the electric power transfer, may be transmitted in response to receiving a first user command from the user. By contrast, a stop command, which causes the smart meter device to prevent the electric vehicle charging device from transferring the electric power, may be transmitted to the smart meter device in response to receiving a second user command the user.

In some embodiments, the smart meter control server is configured to determine electric power consumption by the electric vehicle based on the data record for the electric power transferred to the electric vehicle transmitted by the communication module of the smart meter device. Additionally, the smart meter control server may determine a total cost for charging the electric vehicle based on the electric power consumption determination.

Additional features and aspects of the invention will be described from the following detailed narrative in conjunction with the accompanying drawings, which illustrate by way of example the features in accordance with embodiments of the invention. The summary is not intended to limit the scope of the invention, which is defined solely by the claims attached hereto.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or exemplify embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1A illustrates an EV charging installation where charging is controlled by an ICM smart meter, dispatched through the smart meter network, in accordance with the embodiments disclosed herein.

FIG. 1B illustrates an exemplary EV charging installation of FIG. 1A, where user is authenticated using an NFC tag, in accordance with the embodiments disclosed herein.

FIG. 1C illustrates an exemplary EV charging installation of FIG. 1A, where user is authenticated using an RFID badge, in accordance with the embodiments disclosed herein.

FIG. 1D illustrates an exemplary EV charging installation of FIG. 1A, where user is authenticated using LPR technology, in accordance with the embodiments disclosed herein.

FIG. 2 illustrates an example ICM smart meter control charging system of the example system of FIG. 1A, according to an implementation of the disclosure.

FIG. 3 illustrates an example Smart Meter Control server of the example system of FIG. 1A, according to an implementation of the disclosure.

FIGS. 3-9 illustrate example mobile application screens used by drivers to control vehicle charging in the smart meter control system shown in FIGS. 1A-1D, in accordance with embodiments disclosed herein.

FIG. 10 illustrates example computing system that may be used in implementing various features of embodiments of the disclosed technology.

The figures are not intended to be exhaustive or to limit the invention to the precise form disclosed. The figures are not drawn to scale. It should be understood that the disclosed technology can be practiced with modification and alteration, and that the disclosed technology be limited only by the claims and the equivalents thereof.

### DETAILED DESCRIPTION OF THE EMBODIMENTS

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments can be practiced without some of these details. Moreover, for the purpose of clarity, certain technical material that is understood in the related art has not been described in detail in order to avoid unnecessarily obscuring the disclosure. Furthermore, the disclosure, as illustrated and described herein, may be practiced in the absence of an element that is not specifically disclosed herein.

As EV adoption increases, a growing number of charging site operators are installing EVSE. Often, charging site operators engage third-party Electric Vehicle Service Providers (EVSP) who offer services related to EV charging, including managing a network of charging stations, providing subscription plans for charging services, handling billing and payment systems, and/or offering maintenance and support for the EVSE. Some EVSPs might operate their own EVSE or manage EVSE owned by other parties.

Existing Solutions that Use Hard-Wired Unit

Presently, there are several methods for controlling EV charging in private settings. For example, some EVSE manufacturers and operators utilize a central hardware control unit (e.g., the Hydra unit utilized by Liberty Access Technologies) to control the power flow to the charging stations. The central hardware control unit may include several meters configured to collect power consumption data for individual EVSE connected to the control unit. Drivers can use a pin pad that is hard-wired to the control unit in order to turn on and off charging stations.

Other EVSE manufacturers and operators build the meter and control unit directly in to the EVSE. These EVSEs may be network-connected and communicate with a remote server via communication link over cellular network, e.g., a local area network (LAN) (e.g., LAN may be a wireless local area network (WLAN) or a powerline communication network). The command to enable or disable charging may be sent over the network, which allows the EV operator to connect to the EVSE through a client communication device over WLAN or a wireless personal network (WPAN). This allows the charging site operator to access and monitor power consumption by the EV remotely, with data stored on a remote server. While the EVSE may be controlled remotely over a cellular network, not all private charging site operators have access to this level of control and instead are reliant on third-party software solutions.

Furthermore, EVSE control though WLAN networks can pose several challenges for private charging site operators. First, the information provided by wireless network providers regarding, e.g., energy consumption may be inaccurate and/or incomplete, thereby complicating billing and/or power management. Second, the cost associated with managing WLAN networks, including direct data fees and overhead costs is often borne by charging site operators. Third, authorization and managing vehicle charging by specific vehicle users generally requires users to provide account information each time they charge, often via a mobile application password, key access with a password, or an RFID chip card. However, as alluded to above, because charging site operators rely on third-party software solutions, user management and control is often associated with additional costs and delays. Accordingly, the control of energy consumption of and data management associated with individual stations by the charging site operator is cumbersome regardless of the EVSE type, ineffective, and costly.

As disclosed herein, the present solution enables charging site operators to use an ICM (Installation Control Module) smart meter to facilitate EV charging by connecting the ICM smart meter to an EVSE and leveraging the remote access and control capabilities of the ICM smart meter to control the EV charging. The ICM smart meter is an advanced metering device that not only measures electricity consumption but also provides enhanced communication capabilities, data processing, and real-time monitoring. In particular, the ICM smart meter enables two-way communication between the meter and the utility provider. This allows for real-time data exchange, remote monitoring, and control. The meter has embedded processing capabilities to analyze consumption patterns, detect anomalies, and generate insights locally before sending data to central systems. Remote users (e.g., utilities or in this case charging site operators) can perform remote operations such as meter reading, disconnects, reconnects, and firmware updates. Finally, ICM smart meters can communicate with other devices, including EVSE and/or such similar devices and/or smart devices within the home, such as thermostats and appliances, enabling demand response and energy efficiency programs.

The ICM smart meter may use various communication technologies to interact with one or more central system and other devices. For example, the ICM smart meter may power line communication (PLC) by utilizing existing electrical wiring to transmit data, eliminating the need for additional communication infrastructure. Additionally, the smart meter may employ cellular communication for data transmission, suitable for areas where PLC are less effective. By using cellular communication network, charging site operators are able to avoid costs associated with WLAN associated with existing EVSE solutions, discussed above.

In essence, by connecting the ICM smart meter to an EVSE allows charging site operators to control of energy consumption of and data management associated with individual stations more effectively and without additional costs related to EVSE-specific third-party management solution, WLAN costs, and so on. Indeed, because the control and management occur at the ICM meter level, the EVSE is essentially a “dummy” charging station connected to the ICM meter. For example, the ICM smart meter measures the electricity consumption of the EV charging station, communicates with the EVSE to control the charging process, such as starting or stopping charging, adjusting charging rates, or scheduling charging sessions, and transmits data regarding charging activity, energy usage, and other relevant information to a central system for monitoring and analysis. ICM smart meter often includes smart features such as remote access and control, integration with energy management systems, and compatibility with demand response programs. By utilizing these ICM meter features, including, e.g., remote disconnect and reconnect capability of the ICM smart meter, the present embodiments allow charging site operators to remotely control the charging process (e.g., remotely turn on or turn off EVSE), without the need of an external EVSP.

The Smart Meter Control technology described in this application improves upon existing methods of controlling EV charging in private settings by improving data access and control by the EVSE operator without the need for a third-party managed network. In this embodiment a single utility smart meter is installed between the power source and a single EVSE. This one-to-one configuration between the smart meter and the EVSE allows the charging site operator to manage charging at each individual EVSE by using the smart meter remote connect/disconnect ability. By curtailing the power flow at the ICM smart meter rather than at the EVSE, the charging site operator can collect charging data associated with each individual charging station through the ICM smart meter, thereby avoiding relying on an internal meter within the EVSE. Administering charging and collecting data through the smart meter rather than an internal EVSE meter is expected to improve data quality and simplify control.

By utilizing the ICM smart meter, the present embodiments provide control of the EV charging installation that may not be achieved with other electrical system components, including, e.g., a powerline communicator, a remote intelligent power flow (IPF) module, and other such similar components.

For example, a powerline communicator, which is a general-purpose device used for communication over electrical power lines, may enable data transmission by modulating signals onto the electrical wiring in a building or infrastructure. However, unlike the ICM smart meter, the powerline communicator does not provide a one-to-one pairing with a charging device resulting in a less efficient control over the charging process.

Similarly, a remote intelligent power flow (IPF) module is typically used in smart grid systems or advanced power distribution networks. Its primary function is to monitor and manage the flow of electrical power within the grid. It often includes features such as real-time monitoring of power flow, fault detection, voltage regulation, and the ability to reroute power dynamically to optimize efficiency and reliability. While both IPF module and ICM smart meter involve monitoring and managing electrical systems, they operate at different scales and focus on different aspects of power management. The IPF module operates at the grid level, managing power flow across a broader network, while the ICM smart meter operates at a more localized level, specifically within EV charging station.

By contrast, ICM smart meters may utilize PLC to transmit data over existing power lines. In this method, the data is modulated and sent along the electrical wires to a data concentrator or gateway, which then forwards the information to the desired destination. Further, in installations where wired connectivity is feasible, ICM smart meters may use Ethernet or other wired communication protocols to transmit data to a central system. Zigbee and similar mesh networking protocols can also be used for data transmission in smart metering systems. ICM smart meters can communicate with each other and with a central hub using this type of mesh network. For short-range communication, some ICM smart meters may utilize Bluetooth or Near Field Communication (NFC) technology. This could be used, for example, for local configuration or data retrieval by maintenance personnel. Furthermore, the present solution allows driver authentication using the NFC, RFID, or optical recognition technology, as described in detail herein.

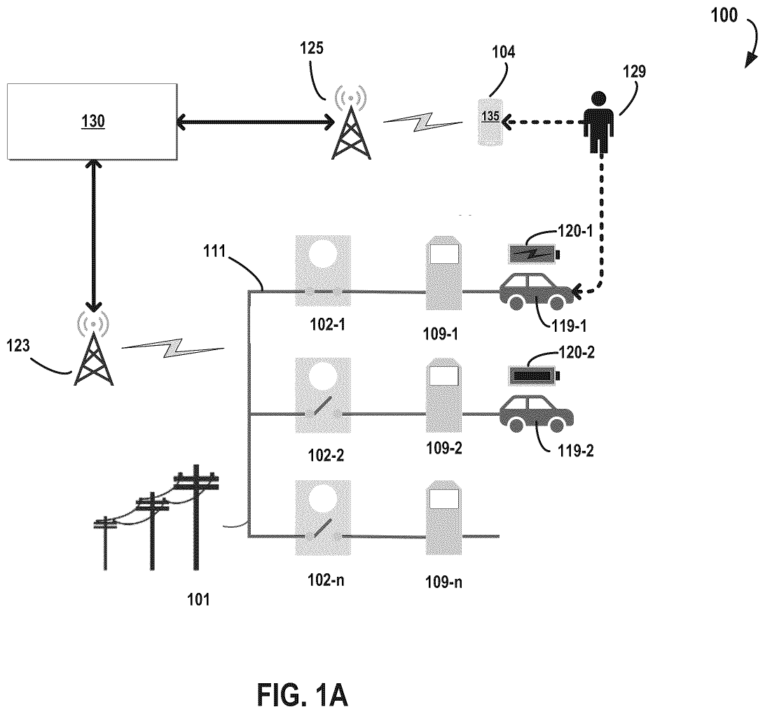

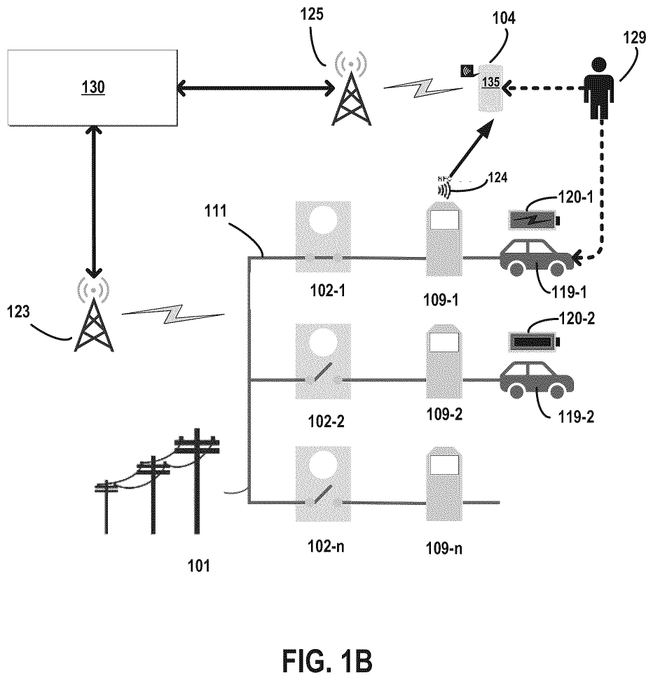

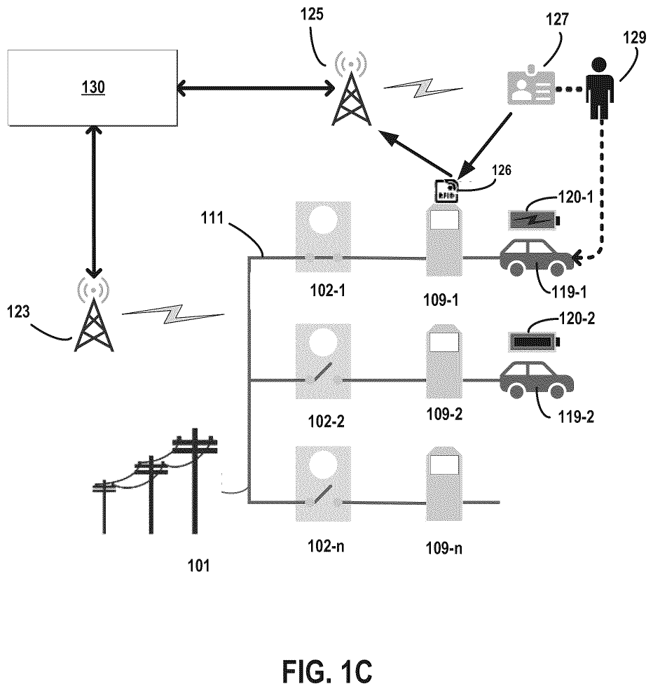

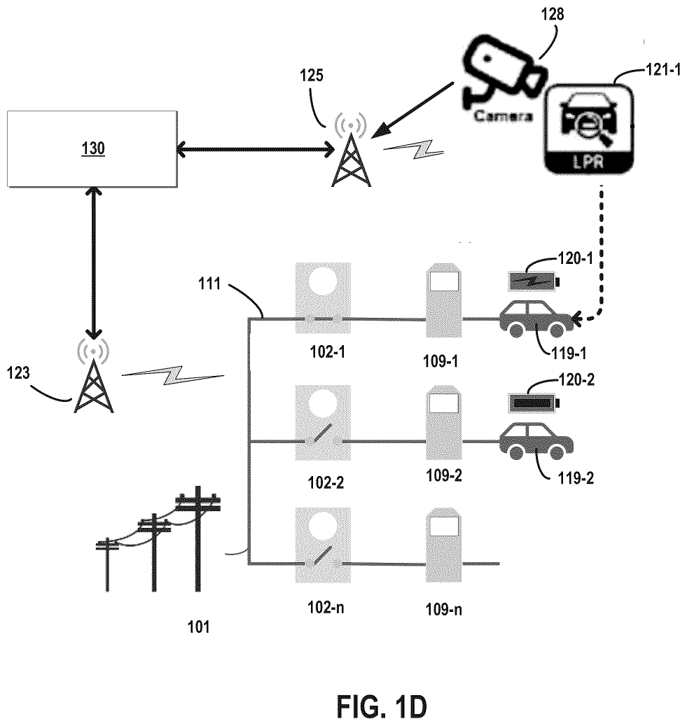

FIG. 1A is a diagram illustrating an EV charging installation site where charging is controlled by an ICM smart meter, dispatched through a smart meter network, referred to as system 100. In some embodiments, system 100 comprises a plurality of ICM smart meters 102-1 . . . -n (hereafter, smart meter 102 or a plurality of smart meters 102-1 . . . -n), each smart meter equipped with a charging device (i.e., EVSE) 109-1 . . . -n (hereafter, charging device 109, charging station 109, or a plurality of charging devices or stations 109-1 . . . -n), respectively, a power distribution grid 101, a smart meter network 123, and a smart meter control server 130. Power distribution grid 101 may be the electrical supply grid owned and operated by a local utility company. As illustrated, ICM smart meter 102 connects charging device 109 to power grid 101. In essence, the ICM smart meter is installed with each charging device (as illustrated, each ICM smart meter 102-1 . . . -n is installed with a charging device 109-1 . . . -n, respectively). By using the ICM smart meter 102 to connect charging device 109 to the power distribution grid 101, the charging site operator and/or vehicle operator 129 can control the electric power 111 flow to charging device 109 by using the existing remote disconnect and reconnect commands associated with ICM smart meter 102.

In some embodiments, electrical power may be delivered to the power consuming device (e.g., vehicle 119-1 and 119-2) via charging device 109-1 and 109-2, respectively, while ICM smart meter 102-1 and 102-2 measures the power consumption of each power consuming device 119-1, 119-2. In some embodiments, ICM smart meter 102-1 . . . -n may couple the energy charging device 109-1 . . . -n to power grid 101 by using a separable connector such as a flexible cable or flexible conduit containing insulated wires.

In some embodiments, ICM smart meters may use wireless communication technologies such as Wi-Fi, cellular networks (3G, 4G, or 5G), or low-power wide-area networks (LPWAN) like LoRaWAN or NB-IoT. These wireless connections enable the meters to transmit data to a central server or cloud-based platform. For example, smart meter network 123 described herein may be one such network.

Further, as illustrated, vehicle operator 129 brings vehicle 119-1 to charge vehicle battery 120-1 at charging device 109-1 by plugging a charging cable associated with charging device 109-1 to vehicle 119-1. Vehicle operator 129 uses the mobile application 135 installed on their client computing device 104 to initiate the charging device 109-1.

The client computing device 104, used by the electric vehicle operator 129, can be any type of WLAN or WPAN compatible device. For example, client computing device 104 may include a one way and two-way RFID devices, an example of the latter being a FasTrac® card; Wi-Fi® devices, such as a personal computer; BlueTooth® devices, such as a mobile phone; and ZigBee® devices.

In some embodiments, client computing device 104 may include a variety of electronic computing devices, such as, for example, a smartphone, tablet, laptop, computer, wearable device, television, virtual reality device, augmented reality device, displays, connected home device, Internet of Things (IoT) device, an enhanced general packet radio service (EGPRS) mobile phone, a media player, a navigation device, a game console, a television, a remote control, or a combination of any two or more of these data processing devices, and/or other devices. In some embodiments, client computing device 104 may present content to a user and receive user input. In some embodiments, client computing device 104 may parse, classify, and otherwise process user input. For example, client computing device 104 may store user input including user access information for authenticating into the user charging application, as will be described in detail below.

In some embodiments, client computing device 104 may be equipped with GPS location tracking and may transmit geolocation information via a wireless link and cellular communication network 125. In some embodiments, server 130 and/or mobile application 135 may use the geolocation information to determine a geographic location associated with user 129. In some embodiments, server 130 may use signal transmitted by client computing device 104 to determine the geolocation of user 129 based on one or more of signal strength, GPS, cell tower triangulation, Wi-Fi location, or other input.

In some embodiments, an access request may be transmitted from client computing device 104 to the smart meter control server 130 via cellular communication network 125. In other embodiments, the access request may be transmitted from via smart meter network 123. The access request may include a set of authentication credentials, payment information, vehicle information, charging station information, and other similar data. Once the smart meter control server 130 authenticates user 129, the user is granted access to the charging station 109-1 and the charging of vehicle 119-1 may begin. At this point electrical power 111 may be transferred from the power grid 101 to vehicle 119-1 via ICM smart meter 102-1 connected to the charging device 109-1.

In some embodiments, vehicle operator 129 may be authenticated by providing information associated with a user account (e.g., username and password) to a client application 135 installed on the client computing device 104 operated by the vehicle operator 129. In some embodiments, vehicle information (e.g., license plate) may be associated with the vehicle operator 129 and used to authenticate the user. For instance, a vehicle may need to first be associated with the user account prior to conducting user authenticating via a mobile application 135 or scanning an NFC tag, described below.

In one embodiment, user authentication may include utilizing NFC, or Near Field Communication protocol. NFC is a set of communication protocols that enable two electronic devices to establish communication by bringing them within close proximity, typically less than ten centimeters (about four inches) from each other and allows data to be transferred. For example, data may be transferred between an NFC tag and a client computing device through electromagnetic induction. NFC is commonly used for a variety of applications, including, contactless payment, access control, and so on. For example, NFC is widely used in mobile payment systems such as Apple Pay, Google Wallet, and Samsung Pay, allowing users to make payments by tapping their NFC-enabled devices (such as smartphones or smartwatches) near a payment terminal. Further, NFC is used in key cards and access control systems, allowing users to gain entry to buildings or restricted areas by tapping their card or device on an NFC reader. NFC tags can be embedded in posters, business cards, or other objects to provide additional information or trigger actions on an NFC-enabled device, such as opening a website or launching an app. NFC can be used to quickly pair Bluetooth devices, like headphones or speakers, by bringing the devices close together.

As illustrated in FIG. 1B, vehicle operator 129 may receive data from an NFC tag 124 located on the charging station 109-1 to client computing device 104, e.g., a mobile phone, acting as an NFC reader. For example, client computing device 104 acting as the NFC reader may generate a magnetic field through an antenna when it is in NFC mode when in close proximity to the NFC tag 124. The generated magnetic field induces a current in the NFC tag's 124 antenna to power the NFC tag 124, which is typically passive (doesn't have its own power source). Once powered, the NFC tag 124 modulates the magnetic field to transfer data back to the client computing device 104. For example, this modulation is done through load modulation, where the tag changes its load on the antenna to encode data. The client computing device 104 detects these changes in the magnetic field and decodes the data being transmitted. The data may include charging station information which may be processed by the mobile application 135 installed on their client computing device 104. For example, the data may be transmitted to the smart meter control server 130 via cellular communication network 125. In response, the server 130 may re-energize the one-to-one ICM smart meter 102-1 to charging station 109-1 pairing to start a charging session by transmitting a signal to the ICM smart meter 1via smart meter network 123.

In one embodiment, user authentication may include using RFID (Radio Frequency Identification) technology. RFID uses electromagnetic fields to automatically identify and track tags attached to objects. RFID is widely used for authentication and access control purposes due to its ability to provide secure, contactless identification. For example, as illustrated in FIG. 1C, user 129 may scan an RFID badge 127 at the RFID scanner 126 located at charging station 109-1 to start a charging session. The RFID badge 127 may be previously associated with a user registered with system 100. By using an authenticated RFID badge, user 129 may start a charging session to charge vehicle 119-1. The signal from the RFID badge 127 may be transmitted by a cellular communication network 125 network to a smart meter control server 130. In some embodiments, the signal transmitted form the RFID badge 127 to the server 130 may be encrypted. In response, the server 130 may re-energize the one-to-one ICM smart meter 102-1 to charging station 109-1 pairing to start a charging session by transmitting a signal to the ICM smart meter 102-1 via smart meter network 123.

In yet another embodiment, user authentication may include License Plate Recognition (LPR) technology. LPR technology is used in optical character recognition (OCR) specifically for identifying and reading license plate information from vehicles. LPR systems use cameras and image processing software to capture and interpret the characters on license plates, allowing for automated vehicle identification and tracking. For example, cameras may be installed in strategic locations such as entrances/exits of parking lots, toll booths, and roadways. These cameras capture images or video of vehicles. To ensure clear images, especially in low light conditions, additional lighting such as infrared (IR) illuminators may be used. The captured images may be enhanced to improve quality, including adjusting brightness, contrast, and removing noise. The LPR technology system identifies the region of interest (ROI) where the license plate is located in the image by using techniques like edge detection, color analysis, morphological operations, and the like. Once the license plate region is identified, individual characters are segmented. This involves separating each character from the others and isolating them for recognition. The segmented characters may be processed using OCR algorithms to interpret and convert them into digital text. In some embodiments, machine learning models, such as convolutional neural networks (CNNs), may be used for high accuracy. The recognized text is compared against known license plate formats and corrected for common OCR errors, improving accuracy. Finally, the recognized license plate number may be checked against a database for various applications, such as verifying vehicle registration, checking for stolen vehicles, or managing parking access. Based on the database match, specific actions are triggered, such as authenticating the user and initiating a charging session.

For example, as illustrated in FIG. 1D, camera 128 may scan a license plate 121-1 of vehicle 129-1. In some embodiments, the LPR technology may identify the license plate number, as described above. The license plate data may be transmitted to the smart meter control server 130 via cellular communication network 125 for authentication and subsequent charging station session initiation. For example, server 130 may process the license plate data to confirm that the license plate is associated with a vehicle whose driver has been previously registered with the system 100. Once the server authenticates the vehicle, the server 130 may re-energize the one-to-one ICM smart meter 102-1 to charging station 109-1 pairing to start a charging session by transmitting a signal to the ICM smart meter 1via smart meter network 123.

In other implementation, the LPR may be implemented in conjunction with one or more above-described authentication methods, e.g., mobile application, NFC tag, RFID and the like. For example, in addition to the user scanning their RFID badge (e.g., RFID badge 127 illustrated in FIG. 1C), the system may also scan the license plate of the vehicle. The user may begin charging only when both authentication systems produce a satisfactory result.

Referring back to FIG. 1A, upon reaching a particular charging threshold, exhausting charging time allotted, or direct charging session termination by user 129, the power flow is disconnected by having the server 130 send a remote disconnect command to ICM smart meter 102.

By utilizing ICM smart meter 102 capabilities to control power consumption, collect power consumption data, and manage user access, the charging device 109 is only used for its power transfer functionality. Conventional charging device must be equipped with separate tools to allow similar capabilities, as previously discussed. However, individual charging device manufacturers may not use consistent features and technology, thus making each charging device installation manufacturer (i.e., hardware) specific. By contrast, by utilizing only the power transfer functionality of the charging device 109, system 100 is hardware agnostic. That is because system 100 can utilize any variety of EVSEs controlled via ICM smart meter 102.

In some embodiments, ICM smart meter 102 may comprise a measurement module and a communication module. In some embodiments, the measurement module may include a voltage and/or current meter, and/or other electrical measurement devices. The measurement module may also include a processor and a memory module to store voltage, current, and other measurements, and to generate a signal if power flow reaches a predetermined threshold value.

In some embodiments, the measurement module may include a communications module which may transmit the signal to a receiver unit. Alternatively, the communication module may be coupled to the measurement module. For example, the communications module may be logically coupled, via a wire or other harness, to ICM smart meter 102. Alternatively, the communications module may transmit a wireless signal via cellular, Wi-Fi, Bluetooth®, Zigbee, or other wireless communications protocol to a remote receiver unit, and ultimately a computer server, workstation, tablet, laptop, handheld or other device. The measurement module may monitor the bidirectional real and reactive power flow through the ICM smart meter 102. This measurement data may be provided to a customer (e.g., a private charge station provider, vehicle owner 129 and/or a utility company) for further energy consumption monitoring. The communication module may provide the measurement data to a data collection device, including a central server (e.g., server 130) or other data handling medium.

In some embodiments, the system 100 including a plurality of ICM smart meters 102-1 . . . -n, coupling a plurality of charging devices 109-1 . . . -n to the power grid 101 may be installed at a particular location (e.g., an office parking lot). ICM smart meter 102 connecting the charging device 109 to the power grid 101 may then be used to gather power consumption information about individual charging stations, as well as to send information or instructions to devices regarding power consumption (e.g., disconnect or reconnect) from a power grid management system (for example, a power utility). As alluded to above, by utilizing the ICM smart meter's 102 capability to communicate with smart meter control server 130 via smart meter network 123, results in server 130 receiving accurate electric power consumption information which may be used for determining power termination threshold when sending instructions to control the power to charging device 109 and/or to generate customer billing, in accordance with instructions stored therein.

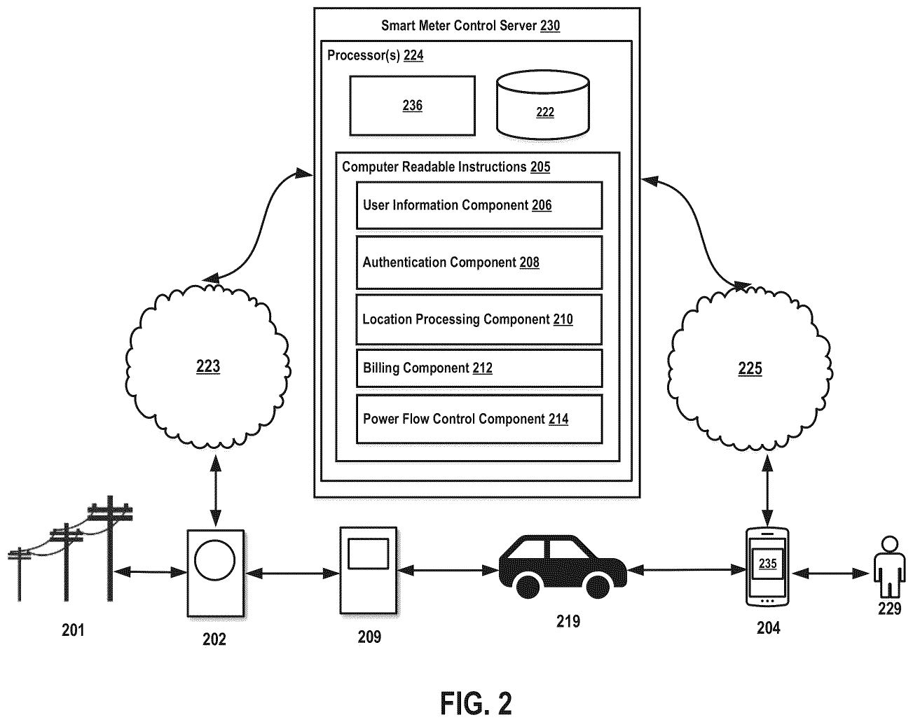

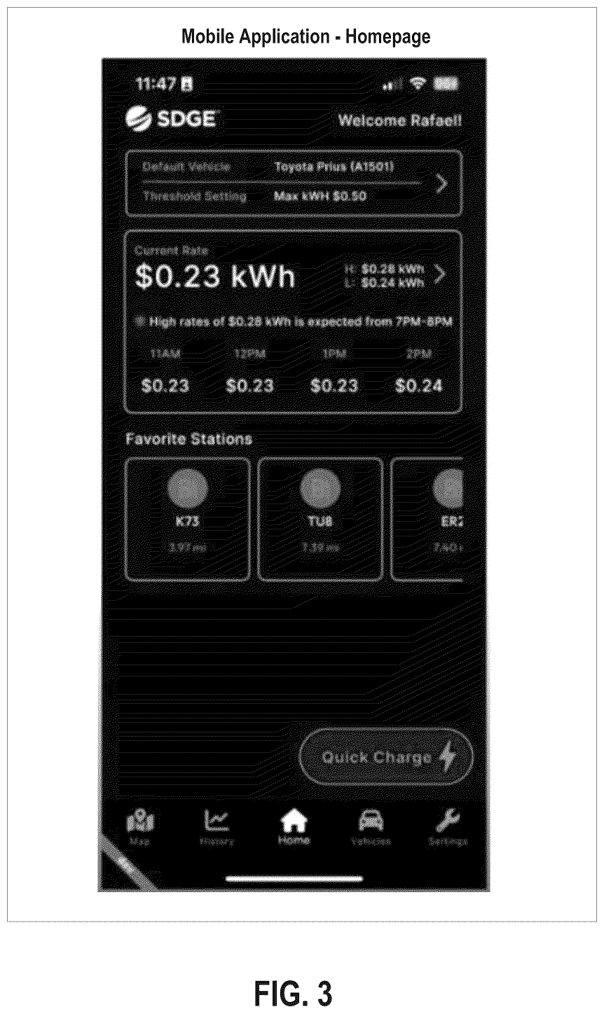

FIG. 2 illustrates an example smart meter control server 230 (server 130 illustrated in FIGS. 1A-1D) configured in accordance with one embodiment. Processor(s) 224 may be one or more central processing units (CPUs), semiconductor-based microprocessors, and/or other hardware devices suitable for retrieval and execution of instructions 206-214 stored in machine-readable storage medium 205. Processor(s) 224 may fetch, decode, and execute instructions to control processes or operations for optimizing the system during run-time. As an alternative or in addition to retrieving and executing instructions, processor(s) 224 may include one or more electronic circuits that include electronic components for performing the functionality of one or more instructions, such as a field programmable gate array (FPGA), application specific integrated circuit (ASIC), or other electronic circuits.

A computer readable storage medium, such as machine-readable storage medium 205 may be any electronic, magnetic, optical, or other physical storage device that contains or stores executable instructions. Thus, machine-readable storage medium 205 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 205 may be a non-transitory storage medium, where the term “non-transitory” does not encompass transitory propagating signals. As described in detail below, machine-readable storage medium 205 may be encoded with executable instructions, for example, instructions 206-214, and/or for running various processes and engines described throughout the disclosure.

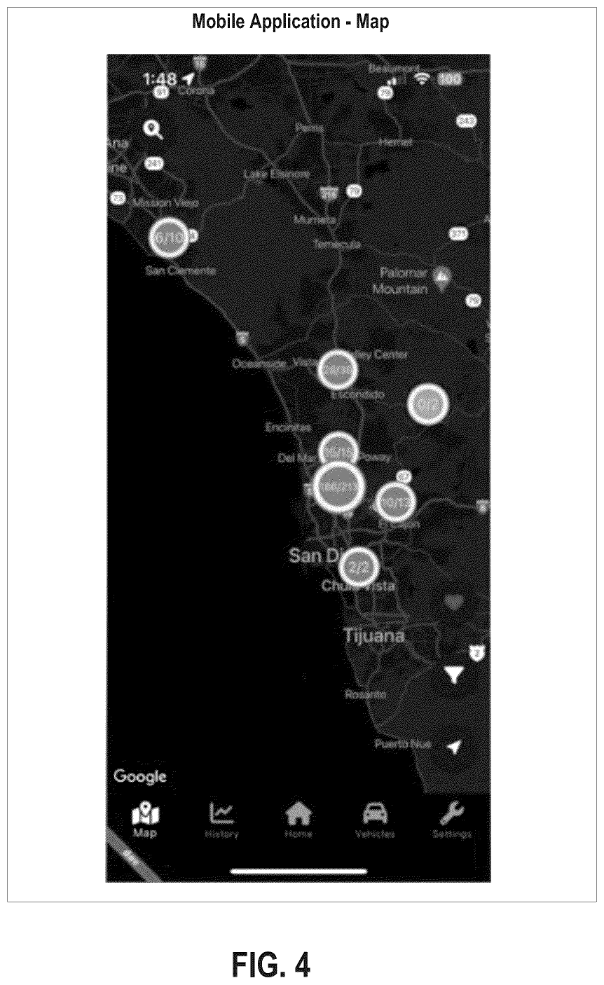

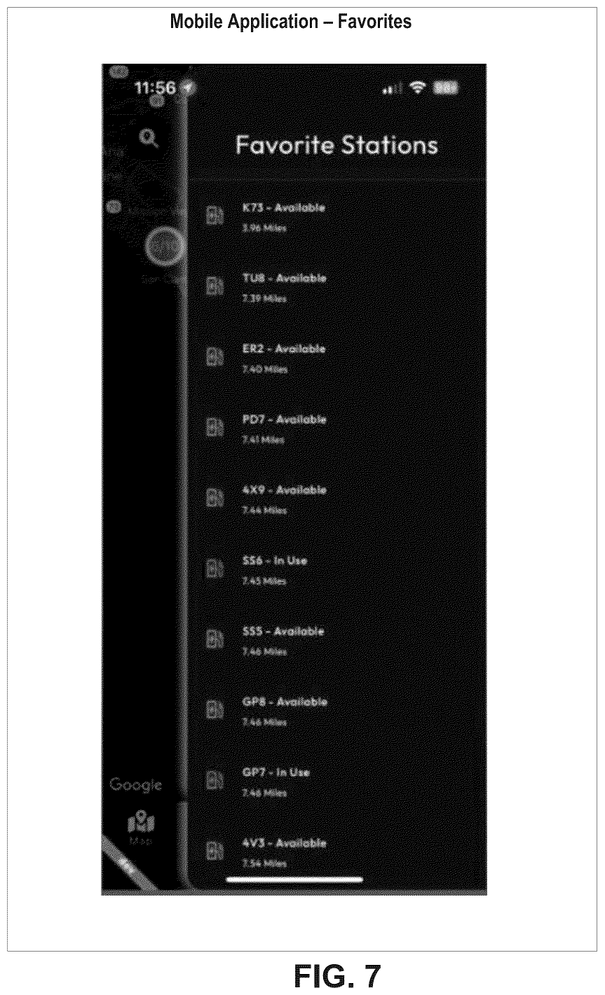

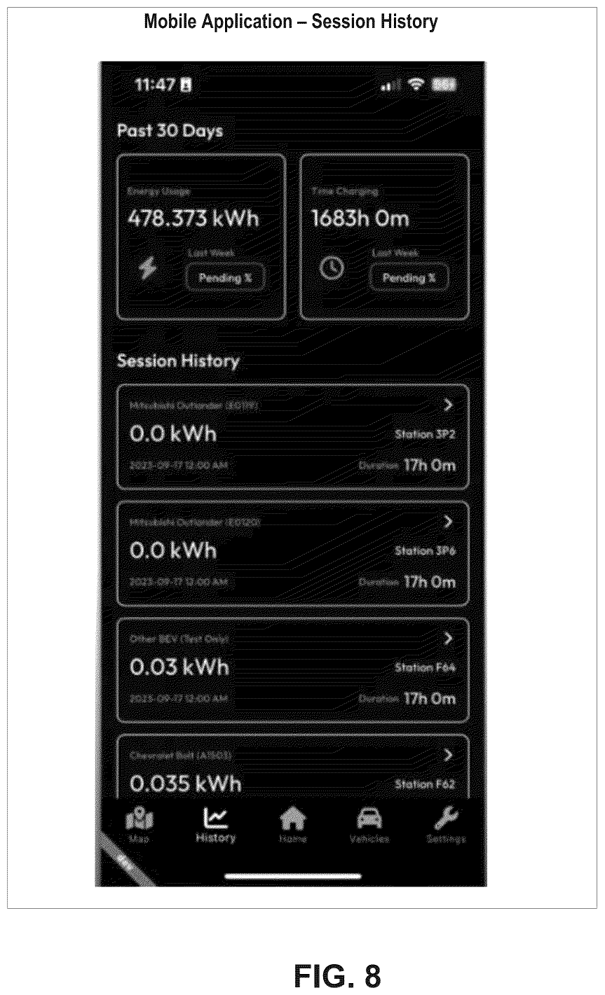

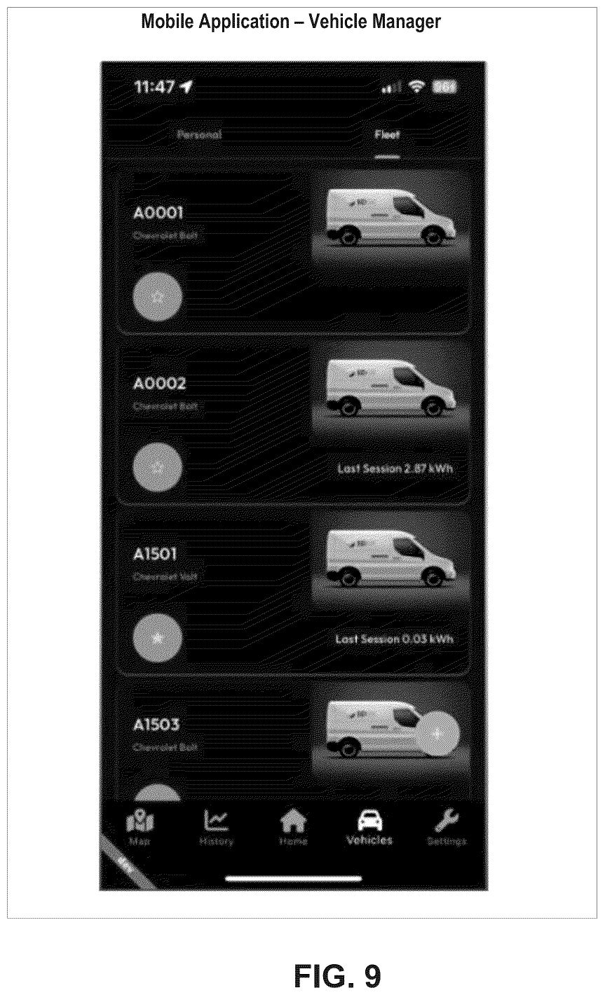

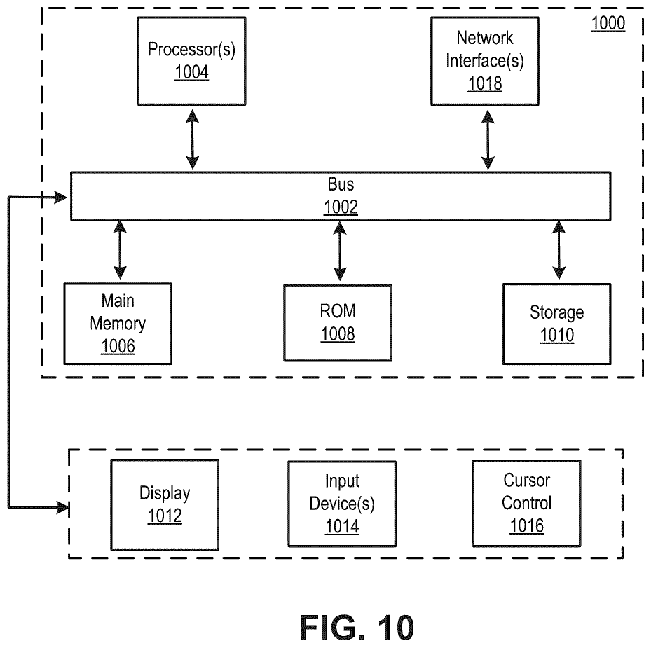

In some embodiments, as alluded to above, smart meter control server 230 may include a distributed application 236 and a corresponding client application 235 running on client computing device 204. The client application 235 may be configured to run as a mobile application on client computing device 204 (e.g., illustrated in FIGS. 4-10), or as a web-based application. The corresponding client application 235 may be configured to provide client functionality to enable vehicle operator 229 to manage EV charging. For example, user 229 can monitor the power flow to vehicle 219 using the mobile application 235 installed on client computing device 204. This can be implemented by allowing user 229 access to the data record of the power consumed by the electric vehicle 219, which is monitored by ICM smart meter 202 and stored on the server 230.

The smart meter control server 230 may be configured to receive data from ICM smart meter 202 and client computing device 204. For example, and as alluded to earlier, ICM smart meter 202, which connects charging device 209 to power grid 201, communicates with server 230 via smart meter network 223. By contrast, client computing device 204 communicates with the smart meter control server 230 via cellular communication network 225.

In some embodiments, distributed application 236 may be operable by one or more processor(s) 224 configured to execute computer readable instructions 205 comprising applications, engines, or modules, including computer program components. In some embodiments, the computer program components may include one or more of a user information component 206, an authentication component 208, a location processing component 210, a billing component 212, a power flow control component 214, and/or other such components. In some embodiments, the various below-described components of FIG. 2 may be used to initiate application 235 within client computing device 204.

Prior to utilizing application 235, users may first have to enroll in a program offered by the charging site operator. For example, the program may include a workplace or facility charging program. The enrollment may include the user providing user information including user biometric information, mobile number associated with client computing device 104, vehicle information, including vehicle manufacturing year, make and model, vehicle identification number (VIN), license plate information, and charging site information (e.g., site access code, site identification number), user preferences (e.g., favorite charging site location), and other such similar information. In some embodiments, user information component 206 may include RFID badge information (e.g., RFID badge 127 illustrated in FIG. 1C) issued to the user. In some embodiments, user information component 206 may be configured to obtain, manage, and store user input associated with user profile. In some embodiments, user information component 206 may store user information within database 222. Once user information is received, the user information component 206 may generate a username and password for accessing the application 135. The user information may be transmitted from client computing device 204 to the smart meter control server 230 via cellular communication network 225.

In some embodiments, the authentication component 208 may be configured to process user input to validate that user's registration requirements. For example, authentication component 208 may be configured to process user input comprising username and password generated by user information component 206.

In some embodiments, the authentication component 208 may be configured to process user input comprising a signal associated with an NFC tag (e.g., NFC tag 124 illustrated in FIG. 1B) scanned by user computing device 204. The authentication component 208 may process the NFC tag information (e.g., charging site information) along with other user data transmitted by the computing device 204, including username and password that may be automatically transmitted by scanning the NFC tag. The authentication component 208 may validate user's account by ensuring the user associated with the username and password is authorized to charge at the location associated with the NFC tag.

In some embodiments, the authentication component 208 may be configured to process user input comprising a signal associated with an RFID badge (e.g., RFID badge 127 illustrated in FIG. 1C) scanned at an RFID scanner (e.g., RFID scanner 126 illustrated in FIG. 1C). The authentication component 208 may process the RFID badge information by determining user account information associated with the RFID badge. The authentication component 208 may validate user's account by ensuring the user associated with the RFID badge is authorized to charge at the location associated with the RFID scanner.

In yet other embodiments, the authentication component 208 may be configured to process user input comprising a license plate information received from an LPR system (e.g., LPR system 128 illustrated in FIG. 1D). The authentication component 208 may process the license plate information by determining user account information associated with the license plate. The authentication component 208 may validate user's account by ensuring the user associated with the license plate is authorized to charge at the location associated with the LPR system.

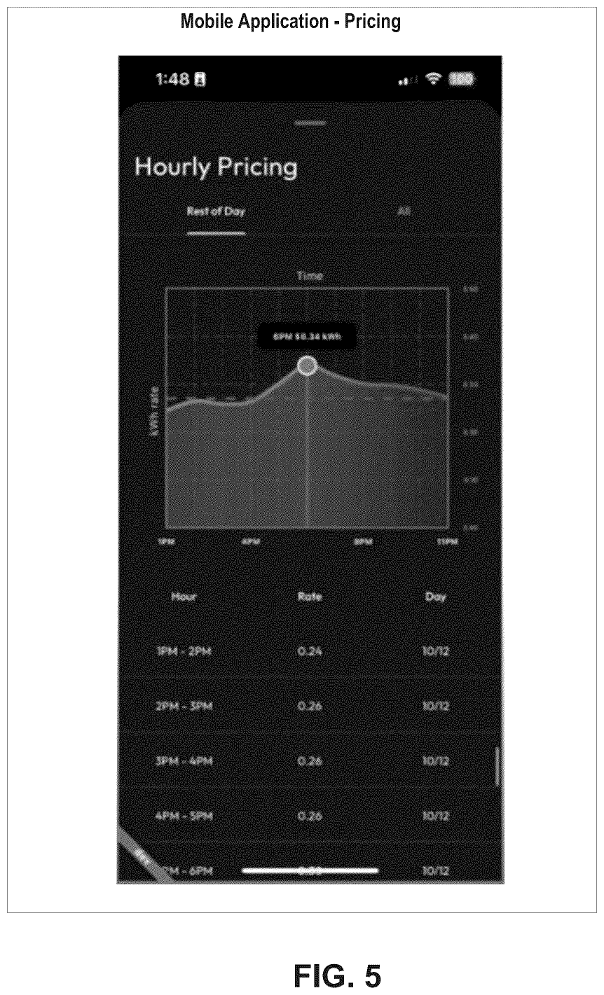

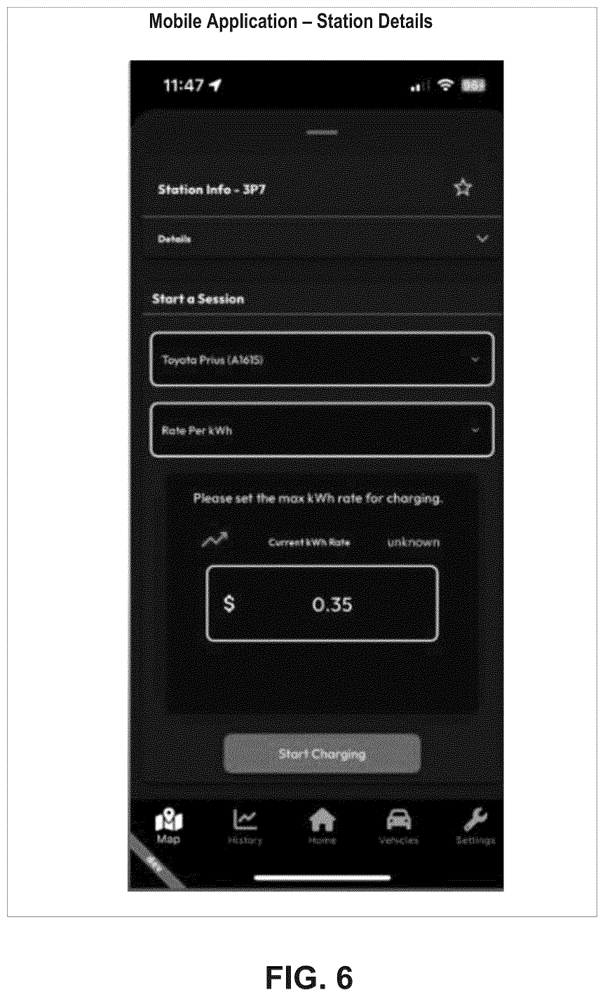

In some embodiments, location processing component 210 may be configured to process user input (e.g., user's preferred charging location) obtained by user information component 206 to present a map generated for the preferred geographic area showing one or more charging stations. Alternatively, location processing component 210 may be configured to process GPS location information associated with client computing device 204 when presenting the map generated for the area showing one or more charging stations. For example, as illustrated in FIG. 4, the map shows charging stations within a geographical area associated with the user. Additionally, location processing component 210 may be configured to present information associated with each charging station such as station name, address, directions, and pricing. for example as illustrated in FIGS. 5, 6.

In some embodiments, billing component 212 may be configured to process meter data obtained from the ICM smart meter 202 and generate session data comprising a summary of the corresponding vehicle charging session. For example, as illustrated in FIGS. 4,5 client application 235 may display information such as charging session start time, duration, energy consumed, total cost, location, and the type of vehicle. In some embodiments, billing component 212 may be configured to provide a summary of all charging sessions for that user, at a plurality of charging stations at a plurality of locations. In other words, billing component 212 may be configured to process meter data from multiple Smart Meters for a particular user profile, for as illustrated in FIG. 4.

In some embodiments, billing component 212 may be configured to identify any gaps in charging intervals by virtue of the one-to-one relationship between each charging session and each ICM smart meter 202.

In some embodiments, billing component 212 may be configured to record energy consumption after every fifteen-minute interval until the session is terminated.

In some embodiments, billing component 212 may be configured to identify irregular charging intervals. For example, intervals with negative kWh values or intervals with excessively large values

In some embodiments, power flow control component 214 may be configured to effectuate disconnect or reconnect commands to ICM smart meter 202 thus terminating and starting the power flowing to the charge station 209. For example, user 229 may use mobile application 235 on their client computing device 204 when disconnecting or reconnecting to the ICM smart meter 202.

As used herein, the term module might describe a given unit of functionality that can be performed in accordance with one or more embodiments of the technology disclosed herein. As used herein, a module might be implemented utilizing any form of hardware, software, or a combination thereof. For example, one or more processors, controllers, ASICs, PLAS, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that physically or electrically separate hardware or software components are used to implement such features or functionality.

Where components or modules of the technology are implemented in whole or in part using software, in one embodiment, these software elements can be implemented to operate with a computing or processing module capable of carrying out the functionality described with respect thereto. One such example computing module is shown in FIG. 11. Various embodiments are described in terms of this example-computing module 1100. After reading this description, it will become apparent to a person skilled in the relevant art how to implement the technology using other computing modules or architectures.

FIG. 11 illustrates an example computing module 1100, an example of which may be a processor/controller resident on a client computing device, or a processor/controller used to operate a payment transaction device, that may be used to implement various features and/or functionality of the systems and methods disclosed in the present disclosure.

Computing module 1100 might include, for example, one or more processors, controllers, control modules, or other processing devices, such as a processor 1104. Processor 1104 might be implemented using a general-purpose or special-purpose processing engine such as, for example, a microprocessor, controller, or other control logic. In the illustrated example, processor 1104 is connected to a bus 1102, although any communication medium can be used to facilitate interaction with other components of computing module 1100 or to communicate externally.

Computing module 1100 might also include one or more memory modules, simply referred to herein as main memory 1108. For example, preferably random-access memory (RAM) or other dynamic memory might be used for storing information and instructions to be executed by processor 1104. Main memory 1108 might also be used for storing temporary variables or other intermediate information during execution of instructions to be executed by processor 1104. Computing module 1100 might likewise include a read only memory (“ROM”) or other static storage device coupled to bus 1102 for storing static information and instructions for processor 1104.

The computing module 1100 might also include one or more various forms of information storage devices 1110, which might include, for example, a media drive 1112 and a storage unit interface 1120. The media drive 1112 might include a drive or other mechanism to support fixed or removable storage media 1114. For example, a hard disk drive, a floppy disk drive, a magnetic tape drive, an optical disk drive, a CD or DVD drive (R or RW), or other removable or fixed media drive might be provided. Accordingly, storage media 1114 might include, for example, a hard disk, a floppy disk, magnetic tape, cartridge, optical disk, a CD or DVD, or other fixed or removable medium that is read by, written to or accessed by media drive 1112. As these examples illustrate, the storage media 1114 can include a computer usable storage medium having stored therein computer software or data.

In alternative embodiments, information storage devices 1110 might include other similar instrumentalities for allowing computer programs or other instructions or data to be loaded into computing module 1100. Such instrumentalities might include, for example, a fixed or removable storage unit 1122 and a storage unit interface 1120. Examples of such storage units 1122 and storage unit interfaces 1120 can include a program cartridge and cartridge interface, a removable memory (for example, a flash memory or other removable memory module) and memory slot, a PCMCIA slot and card, and other fixed or removable storage units 1122 and interfaces 1120 that allow software and data to be transferred from the storage unit 1122 to computing module 1100.

Computing module 1100 might also include a communications interface 1124. Communications interface 1124 might be used to allow software and data to be transferred between computing module 1100 and external devices. Examples of communications interface 1124 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 1124 might typically be carried on signals, which can be electronic, electromagnetic (which includes optical) or other signals capable of being exchanged by a given communications interface 1124. These signals might be provided to communications interface 1124 via a channel 1128. This channel 1128 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 1108, storage unit interface 1120, media 1114, and channel 1128. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 1100 to perform features or functions of the present application as discussed herein.

Various embodiments have been described with reference to specific exemplary features thereof. It will, however, be evident that various modifications and changes may be made thereto without departing from the broader spirit and scope of the various embodiments as set forth in the appended claims. The specification and figures are, accordingly, to be regarded in an illustrative rather than a restrictive sense.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the present application, whether or not such embodiments are described and whether or not such features are presented as being a part of a described embodiment. Thus, the breadth and scope of the present application should not be limited by any of the above-described exemplary embodiments.

Terms and phrases used in the present application, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A system for remotely managing electric power transfer, the system comprising:
a power source;
an electric vehicle charging device configured to transfer electric power from the power source to an electric vehicle;
a smart meter device coupled to the electric vehicle charging device on one end and the power source on another end, wherein the smart meter device is configured to transmit electrical charging data and receive remote commands, via a wireless network, for controlling the electric power being transferred by the electric vehicle charging device; and
a smart meter control server communicatively coupled to the smart meter device, wherein the smart meter control server is configured to receive user input transmitted via a mobile network;
wherein the smart meter control server is configured to verify that the user input comprising authentication credentials received from a mobile device operated by a user matches user account credentials associated with the user to permit power transfer to the electric vehicle; and
wherein the smart meter control server, upon verifying that the authentication credentials match the user account credentials, is configured to remotely control the smart meter device by:
transmitting a start command to the smart meter device in response to receiving a first user command from the user, wherein the start command causes the smart meter device to permit the electric vehicle charging device to start the electric power transfer; and
transmitting a stop command to the smart meter device in response to receiving a second user command the user, wherein the stop command causes the smart meter device to prevent the electric vehicle charging device from the electric power transfer.

2. The system of claim 1, wherein the user input comprises an NFC tag information transmitted by the mobile device operated by the user.

3. The system of claim 1, wherein the user input comprises an RFID badge information transmitted by an RFID scanner.

4. The system of claim 1, wherein the user input comprises license plate information transmitted by an LPR scanner.

5. The system of claim 1, wherein the smart meter device is configured to communicate with the smart meter control server via a smart meter network.

6. The system of claim 5, wherein the smart meter device comprises a measurement module and a communication module.

7. The system of claim 5, wherein the measurement module of the smart meter device comprises a processor and a memory, the measurement module configured to collect and store voltage and current information associated with electric power transferred from the power source to the electric vehicle via the electric vehicle charging device.

8. The system of claim 7, wherein the communication module of the smart meter device is configured to transmit the voltage and the current information collected by the measurement module to the smart meter control server.

9. The system of claim 4, wherein the measurement module of the smart meter device generates a data record for the electric power transferred from the power source to the electric vehicle via the electric vehicle charging device, wherein the record is transmitted to the smart meter server by the communication module of the smart meter device.

10. The system of claim 9, wherein the smart meter control server is configured to determine electric power consumption by the electric vehicle based on the data record for the electric power transferred to the electric vehicle transmitted by the communication module of the smart meter device.

11. The system of claim 10, wherein the smart meter control server determines a total cost for charging the electric vehicle based on the electric power consumption determination.

12. A method for remotely managing electric power transfer, the method comprising:
providing an electric vehicle charging device coupled to a power source, wherein the electric vehicle charging device is configured to transfer electric power from the power source to an electric vehicle;
coupling a smart meter device to the electric vehicle charging device on one end and the power source on another end;
communicatively coupling the smart meter device to a smart meter control server, wherein the smart meter control server is configured to receive access information transmitted, via a mobile network;
verifying, by the smart meter server, that the user input comprising authentication credentials received from a mobile device operated by a user matches user account credentials associated with the user to permit power transfer to the electric vehicle;
responsive to verifying that the authentication credentials match the user account credentials, remotely controlling the electric power being transferred by the electric vehicle charging device by:
transmitting a start command from the smart meter control server to the smart meter device upon the smart meter control server receiving a first user command from the user, wherein the start command causes the smart meter device to permit the electric vehicle charging device to start the electric power transfer;
transmitting a stop command from the smart meter control server to the smart meter device upon the smart meter control server receiving a second user command the user, wherein the stop command causes the smart meter device to prevent the electric vehicle charging device from the electric power transfer.

13. The method of claim 9, wherein the user input comprises an NFC tag information transmitted by the mobile device operated by the user.

14. The method of claim 9, wherein the user input comprises an RFID badge information transmitted by an RFID scanner.

15. The method of claim 9, wherein the user input comprises license plate information transmitted by an LPR scanner.

16. The method of claim 9, further comprising communicating, by the smart meter device, with the smart meter control server, via a smart meter network.

17. The method of claim 13, wherein the smart meter device comprises a measurement module and a communication module.

18. The method of claim 14, wherein controlling the electric power comprises collecting and storing voltage and current information associated with electric power transferred from the power source to the electric vehicle via the electric vehicle charging device by a measurement module of the smart meter device.

19. The method of claim 15, wherein the voltage and the current information collected by the measurement module is transmitted to the smart meter control server by a communication module of the smart meter device.

20. The method of claim 15, wherein the measurement module of the smart meter device generates a data record for the electric power transferred from the power source to the electric vehicle via the electric vehicle charging device, wherein the record is transmitted to the smart meter server by the communication module of the smart meter device.

21. The method of claim 15, further comprising determining, by the smart meter control server, electric power consumption by the electric vehicle information based on the data record for the electric power transferred to the electric vehicle transmitted by the communication module of the smart meter device.
